(19) United States
(12) Patent Application Publication
(10) Pub. No.: US 2025/0031164 A1
(43) Pub. Date: Jan. 23, 2025

(54) METHOD AND DEVICE FOR ESTIMATING FREQUENCY OFFSET AND COMPENSATING RECEIVED SIGNAL IN WIRELESS COMMUNICATION SYSTEM

(71) Applicant: Samsung Electronics Co., Ltd., Suwon-si (KR)

(72) Inventors: Eunhye Park, Suwon-si (KR); Jinmin Kim, Suwon-si (KR); Jung Woon Lee, Suwon-si (KR)

(21) Appl. No.: 18/773,964

(22) Filed: Jul. 16, 2024

(30) Foreign Application Priority Data
Jul. 18, 2023 (KR) 10-2023-0093351
Dec. 27, 2023 (KR) 10-2023-0193172

(51) Int. Cl. H04W 56/00; H04L 25/02

(52) U.S. Cl. CPC H04W 56/0035; H04L 25/0204; H04W 56/005

(57) ABSTRACT

An operation method of a wireless communication device includes receiving a first signal including a first reference signal group, calculating a first residual frequency offset based on the first signal, receiving a second signal that is subsequent to the first signal and includes a second reference signal group, compensating a phase of the second signal based on the first residual frequency offset, estimating a first channel based on first channel characteristics, the first reference signal group, and the first signal, estimating a second channel based on second channel characteristics, the second reference signal group, and the second signal of which the phase is compensated, and calculating a second residual frequency offset based on the first channel estimation and the second channel estimation.

### CROSS-REFERENCE TO RELATED APPLICATION

This application is based on and claims priority under 35 U.S.C. § 119 to Korean Patent Application No. 10-2023-0093351, filed on Jul. 18, 2023, in the Korean Intellectual Property Office, and Korean Patent Application No. 10-2023-0193172, filed on Dec. 27, 2023, in the Korean Intellectual Property Office, the entire disclosures of which are incorporated herein by reference.

### BACKGROUND

Embodiments of the inventive concept relate to a method and device for estimating a frequency offset to improve communication performance, and compensating a received signal by using the estimated frequency offset.

In a wireless communication system, the carrier frequency of a signal transmitted by a transmitting device may be different from the carrier frequency of a received signal recognized by a receiving device. The receiving device may estimate a frequency offset to match the carrier frequency of the transmitted signal with the carrier frequency of the received signal.

In a wireless communication system, the carrier frequency of a signal transmitted by a transmitting device and the carrier frequency of a received signal recognized by a receiving device may differ from each other due to various factors, and a method of accurately estimating a frequency offset with low complexity may be desired.

### SUMMARY

Embodiments of the inventive concept provide a method and device for estimating a frequency offset to improve communication performance.

According to an aspect of the inventive concept, there is provided an operation method of a wireless communication device, the operation method including receiving a first signal including a first reference signal group, calculating a first residual frequency offset based on the first signal, receiving a second signal that is subsequent to the first signal and includes a second reference signal group, compensating a phase of the second signal based on the first residual frequency offset, estimating a first channel based on first channel characteristics, the first reference signal group, and the first signal, estimating a second channel based on second channel characteristics, the second reference signal group, and the second signal of which the phase is compensated, and calculating a second residual frequency offset based on the first channel estimation and the second channel estimation.

According to another aspect of the inventive concept, there is provided a wireless communication device, the wireless communication device including a radio-frequency integrated circuit (RFIC), and a processor configured to: receive through the RFIC a first signal including a first reference signal group, calculate a first residual frequency offset based on the first signal, receive through the RFIC a second signal that is subsequent to the first signal and includes a second reference signal group, compensate a phase of the second signal based on the first residual frequency offset, estimate a first channel based on first channel characteristic, the first reference signal group, and the first signal, estimate a second channel based on second channel characteristics, the second reference signal group, and the second signal of which the phase is compensated, and calculate a second residual frequency offset based on the first channel estimation and the second channel estimation.

According to another aspect of the inventive concept, there is provided an operation method of a wireless communication device, the operation method including receiving a first signal including a first data signal group, calculating a first residual frequency offset based on the first signal, receiving a second signal that is subsequent to the first signal and includes a second data signal group, compensating a phase of the second signal based on the first residual frequency offset, estimating a first channel based on first channel characteristics, the first data signal group, and the first signal, estimating a second channel based on second channel characteristics, the second data signal group, and the second signal of which the phase is compensated, and calculating a second residual frequency offset based on the first channel estimation and the second channel estimation.

### BRIEF DESCRIPTION OF THE DRAWINGS

Embodiments will be more clearly understood from the following detailed description taken in conjunction with the accompanying drawings in which:

FIG. 1 is a block diagram of a wireless communication device according to an embodiment;

FIG. 2 is a block diagram of a wireless communication device according to an embodiment;

FIGS. 3A to 3C illustrate an operation method by which a wireless communication device performs channel characteristics estimation and frequency offset estimation by using a reference signal, according to an embodiment;

FIG. 3D illustrates an operation method by which a wireless communication device performs channel characteristics estimation and frequency offset estimation by using decoded data, according to an embodiment;

FIG. 4 illustrates a procedure in which a wireless communication device performs channel characteristics estimation and frequency offset estimation, according to an embodiment;

FIG. 5A illustrates a training packet structure of Bluetooth Low Energy (LE) High Data Throughput (HDT);

FIG. 5B illustrates a procedure in which a wireless communication device performs channel characteristics estimation and frequency offset estimation by using a reference signal of a Bluetooth LE HDT system, according to an embodiment;

FIG. 6 shows a pseudoalgorithm for a wireless communication device to estimate characteristics of a channel and a frequency offset by using a reference signal, according to an embodiment;

FIG. 7 shows a pseudoalgorithm for a wireless communication device to perform channel characteristics estimation and frequency offset estimation by using decoded data, according to an embodiment;

FIG. 8 shows residual frequency offsets estimated by a wireless communication device according to symbol indices, according to an embodiment;

FIG. 9 is a block diagram of a wireless communication device according to an embodiment;

FIG. 10 is a diagram illustrating a wireless communication system that may include a wireless communication device, according to an embodiment; and

FIG. 11 is a diagram illustrating examples of a device for wireless communication according to an embodiment.

### DETAILED DESCRIPTION OF THE EMBODIMENTS

Hereinafter, embodiments of the inventive concept will be described in detail with reference to the accompanying drawings. The same reference numerals are used for the same components in the drawings, and duplicate descriptions thereof are omitted. As used herein, the term “and/or” includes any and all combinations of one or more of the associated listed items. It is noted that aspects described with respect to one embodiment may be incorporated in different embodiments although not specifically described relative thereto. That is, all embodiments and/or features of any embodiments can be combined in any way and/or combination. In the present specification, although terms such as first and second are used to describe various elements or components, it goes without saying that these elements or components are not limited by these terms. These terms are only used to distinguish a single element or component from other elements or components.

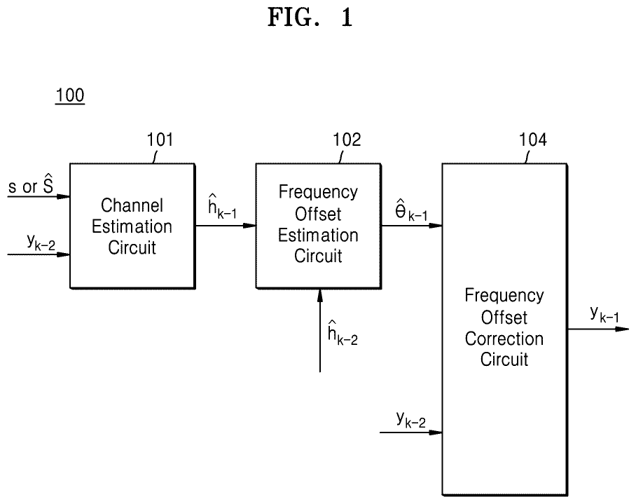

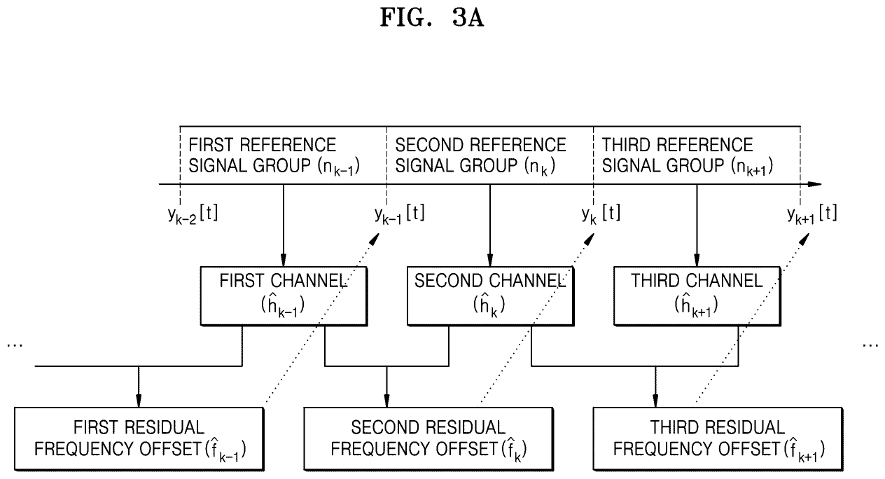

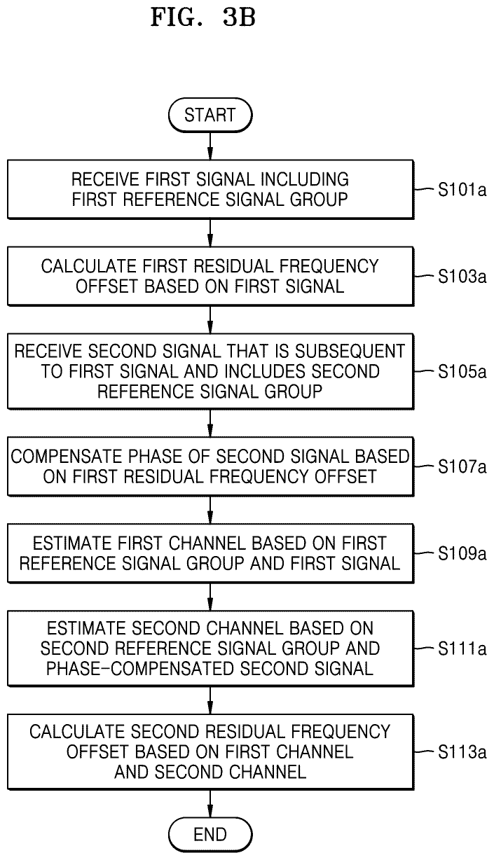

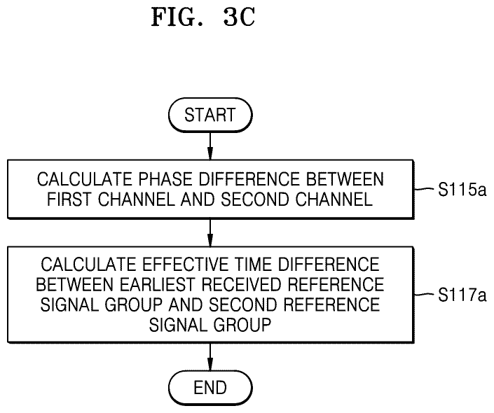

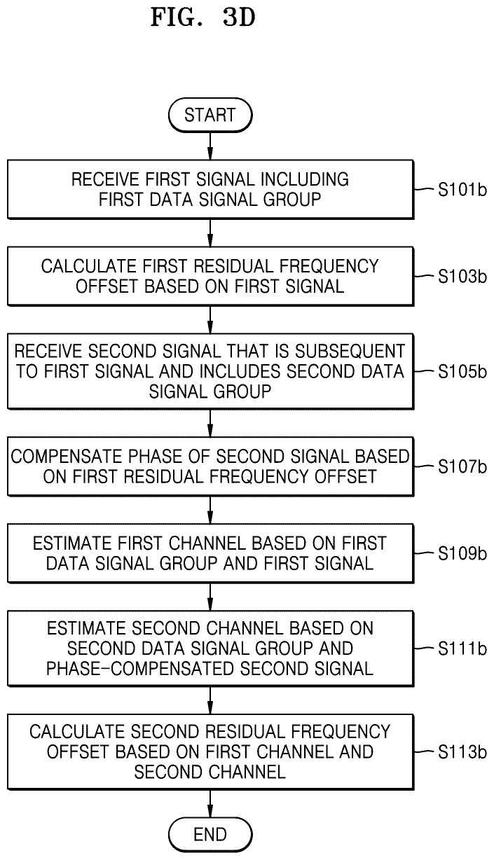

FIG. 1 is a block diagram of a wireless communication device according to an embodiment. FIG. 1 may be described in more detail with reference to FIGS. 3A to 3C.

In a wireless communication system, the carrier frequency of a signal transmitted by a transmitting device may be different from the carrier frequency of a received signal recognized by a receiving device. According to embodiments of the inventive concept, a frequency offset that occurs due to such a difference is referred to as a carrier frequency offset (CFO). When a CFO exists, the receiving device recognizes a subcarrier of a transmitted signal as shifted by a certain frequency interval.

Channel estimation and frequency offset estimation may need to be performed accurately in wireless communication and may affect reception performance. Thus, embodiments of the inventive concept may provide a wireless communication device having a generally simple structure and that is capable of performing accurate channel estimation and frequency offset estimation by using a previously received reference signal or decoded data.

Referring to FIG. 1, a wireless communication device 100 according to an embodiment includes a channel estimation circuit 101, a frequency offset estimation circuit 102, and a frequency offset correction circuit 104. When a signal is received at its destination, it could have errors. To remove the noise and distortion effects of the wireless communication channel from the received signal, the wireless channel's properties may be determined. The process of determining the characteristics of a wireless communication channel is called channel estimation or channel characteristics estimation. The channel characteristics may include, but are not limited to, path loss, fading, interference, and Doppler shift. The wireless communication device 100 may further include components for transmitting and receiving signals, and is not limited to including only the components described above.

yₖ[t] denotes a received signal corrected based on a k-th residual frequency offset. ĥₖ denotes an estimated channel in a k-th symbol group. \hat{θ}ₖ denotes an estimated residual phase offset in the k-th symbol group. \hat{f}ₖ denotes an estimated residual frequency offset in the k-th symbol group.

For example, the wireless communication device 100 may receive a signal s or a decoded data signal ŝ including reference signals. The wireless communication device 100 may divide the reference signals into reference signal groups. The reference signal groups may include a first reference signal group and a second reference signal group. It is assumed that the second reference signal group is a group received subsequent to the first reference signal group. That is, it is assumed that the first reference signal group is a (k−1)-th reference signal group, and the second reference signal group is a k-th reference signal group.

The channel estimation circuit 101 and the frequency offset correction circuit 104 receive a first signal yₖ₋₂ including the first reference signal group. The frequency offset estimation circuit 102 calculates a first residual frequency offset \hat{f}ₖ₋₁ based on the first signal yₖ₋₂. In detail, the frequency offset estimation circuit 102 may calculate the first residual frequency offset \hat{f}ₖ₋₁ by using a phase difference between “a first channel ĥₖ₋₁ estimated through the first signal yₖ₋₂” and “a channel ĥₖ₋₂ estimated through a (k−3)-th received signal yₖ₋₃”. The channel estimation circuit 101 and the frequency offset correction circuit 104 receive a second signal yₖ₋₁ that is subsequent to the first signal yₖ₋₂ and includes the second reference signal group. The frequency offset correction circuit 104 compensates the phase of the second signal yₖ₋₁ based on the first residual frequency offset \hat{f}ₖ₋₁.

The channel estimation circuit 101 may estimate the first channel ĥₖ₋₁ based on the first reference signal group and the first signal yₖ₋₂. The channel estimation circuit 101 may estimate a second channel ĥₖ based on the second reference signal group and the phase-compensated second signal yₖ₋₁. The frequency offset estimation circuit 102 may calculate a second residual frequency offset \hat{f}ₖ based on the first channel ĥₖ₋₁ and the second channel ĥₖ. For example, the frequency offset estimation circuit 102 may calculate a phase difference between the first channel ĥₖ₋₁ and the second channel ĥₖ, and may calculate an effective time difference between the earliest received reference signal group and the second reference signal group. The frequency offset estimation circuit 102 may calculate the second residual frequency offset \hat{f}ₖ by using “the phase difference between the first channel ĥₖ₋₁ and the second channel ĥₖ” and “the effective time difference between the earliest received reference signal group and the second reference signal group”. The effective time difference between the earliest received reference signal group and the second reference signal group may refer to a sum of “half the number of symbols included in the earliest received reference signal group”, “half the number of symbols included in the second reference signal group”, and “the number of symbols received between the earliest received reference signal group and the second reference signal group”.

In addition, the wireless communication device 100 may adjust the number of symbols of the second reference signal group based on the size of the first residual frequency offset \hat{f}ₖ₋₁. For example, when the size of the first residual frequency offset \hat{f}ₖ₋₁ is greater than or equal to a threshold value, the wireless communication device 100 may adjust the number of symbols of the second reference signal group to be less than the number of symbols of the first reference signal group. As another example, when the size of the first residual frequency offset is less than the threshold value, the wireless communication device 100 may adjust the number of symbols of the second reference signal group to be greater than the number of symbols of the first reference signal group.

In addition, the channel estimation circuit 101 and the frequency offset correction circuit 104 may receive a third signal yₖ that is subsequent to the second signal yₖ₋₁ and includes a third reference signal group. The frequency offset correction circuit 104 may compensate the phase of the third signal yₖ based on the second residual frequency offset \hat{f}ₖ.

The wireless communication device 100 according to an embodiment has a generally simple structure and may be configured to accurately estimate a frequency offset and a channel.

The wireless communication device 100 according to an embodiment may estimate a frequency offset by using a reference signal or decoded data.

The wireless communication device 100 according to an embodiment may perform stepwise channel estimation and frequency offset estimation by dividing the reference signal or decoded data into N groups (N is an integer of 2 or greater) and performing channel estimation and frequency offset estimation N times (N is an integer of 2 or greater).

The wireless communication device 100 according to an embodiment may flexibly cope with a channel environment by dividing the reference signal or decoded data into N groups (N is an integer of 2 or greater) while adjusting the number of symbols of each group.

The wireless communication device 100 according to an embodiment may divide the reference signal or decoded data into N groups (N is an integer of 2 or greater), and sequentially perform channel estimation and frequency offset estimation by using information based on a previously received reference signal or decoded data.

The wireless communication device 100 according to an embodiment may compensate the phase of a received signal by calculating a residual phase offset.

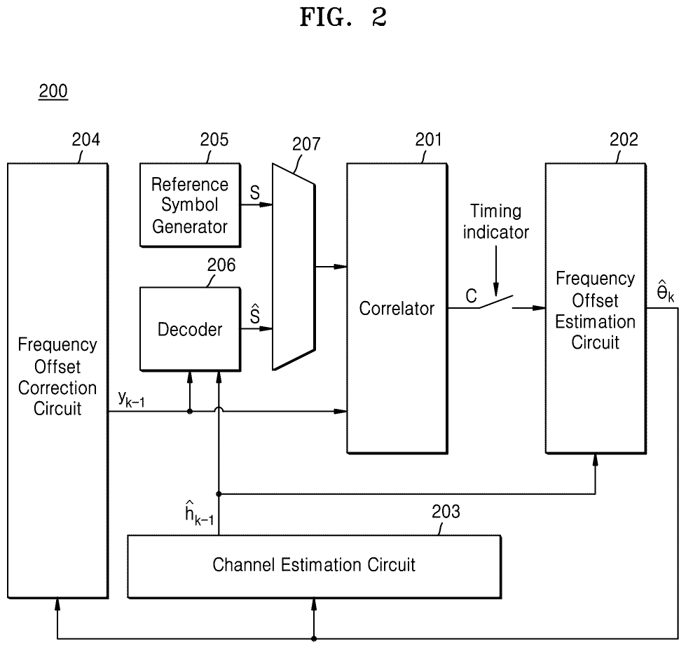

FIG. 2 is a block diagram of a wireless communication device according to an embodiment. FIG. 2 may be described in more detail with reference to FIGS. 3A to 3C.

Referring to FIG. 2, a wireless communication device 200 according to an embodiment may include a correlator 201, a frequency offset estimation circuit 202, a channel estimation circuit 203, a frequency offset correction circuit 204, a reference signal generator 205, a decoder 206, and a multiplexer (MUX) 207.

yₖ[t] denotes a received signal corrected based on a k-th residual frequency offset. ĥₖ denotes an estimated channel in a k-th symbol group. \hat{θ}ₖ denotes an estimated residual phase offset in the k-th symbol group. \hat{f}ₖ denotes an estimated residual frequency offset in the k-th symbol group. The reference signal generator 205 may generate a reference signal S. The decoder 206 may generate a decoded data signal S by decoding a received signal yₖ₋₁.

The correlator 201 may receive any one of the reference signal S or the decoded data signal S from the MUX 207. The correlator 201 may extract a correlation between any one of the reference signal S or the decoded data signal Ŝ, and the received signal yₖ₋₁. Reference signal groups may include a first reference signal group and a second reference signal group. It is assumed that the second reference signal group is a group received subsequent to the first reference signal group. It is assumed that the first reference signal group is a (k−1)-th reference signal group, and the second reference signal group is a k-th reference signal group. k is an integer greater than or equal to 1. It is assumed that a first data signal group is a (k−1)-th data signal group, and a second data signal group is a k-th data signal group. k is an integer greater than or equal to 1.

The frequency offset estimation circuit 202 may estimate a second phase offset \hat{θ}ₖ based on a correlation Cₖ for the second reference signal group, and a first channel ĥₖ₋₁ for the first reference signal group. The frequency offset correction circuit 204 may correct a received signal yₖ by applying the second phase offset \hat{θ}ₖ starting from a symbol subsequent to the last symbol of the second reference signal group.

In addition, the frequency offset correction circuit 204 may correct the received signal yₖ by applying the second phase offset \hat{θ}ₖ starting from a symbol subsequent to the last symbol of the first data signal group. The frequency offset correction circuit 204 may output the corrected received signal yₖ. The channel estimation circuit 203 may output the first channel ĥₖ by updating a second correlation Cₖ based on the second phase offset \hat{θ}ₖ.

FIGS. 3A to 3C illustrate an operation method by which a wireless communication device performs channel estimation and frequency offset estimation by using a reference signal, according to an embodiment. FIG. 3A may be described with reference to FIG. 1.

Referring to FIG. 3A, the wireless communication device 100 may divide reference signals into N groups. The N reference signal groups may include a first reference signal group, a second reference signal group, and a third reference signal group. The first reference signal group is a (k−1)-th group (k is a positive integer), the second reference signal group is a k-th group, and the third reference signal group is a (k+1)-th group. The wireless communication device 100 may configure the first reference signal group with nₖ₋₁ symbols, the second reference signal group with nₖ symbols, and the third reference signal group with nₖ₊₁ symbols. y₀[t] denotes a received signal including reference signals. yₖ[t] denotes a received signal that is phase-corrected based on a k-th residual frequency offset. ĥₖ denotes an estimated channel in a k-th symbol group. \hat{θ}ₖ denotes an estimated residual phase offset in the k-th symbol group. \hat{f}ₖ denotes an estimated residual frequency offset in the k-th symbol group.

In addition, the first reference signal group and the second reference signal group may include any one of a long training sequence (LTS) and an access address (AA). For example, reference signals of the first reference signal group and reference signals of the second reference signal group may be different from each other. In detail, the first reference signal group may include an LTS, and the second reference signal group may include an AA. As another example, the reference signals of the first reference signal group and the reference signals of the second reference signal group may be identical to each other. In detail, both the first reference signal group and the second reference signal group may include an LTS.

Referring to FIG. 3B, in operation S101a, the wireless communication device 200 may receive a first signal yₖ₋₂ including the first reference signal group. In operation S103a, the wireless communication device 200 may calculate a first residual frequency offset \hat{f}ₖ₋₁ based on the first signal yₖ₋₂. For example, the wireless communication device 200 may calculate the first residual frequency offset \hat{f}ₖ₋₁ by calculating a phase difference between “a channel ĥₖ₋₂ estimated through a signal yₖ₋₃ received earlier than the first signal yₖ₋₂” and “a channel ĥₖ₋₁ estimated through the first signal yₖ₋₂”.

In operation S105a, the wireless communication device 200 may receive a second signal yₖ₋₁ that is subsequent to the first signal yₖ₋₂ and includes the second reference signal group. In operation S107a, the wireless communication device 200 may compensate the phase of the second signal yₖ₋₁. based on the first residual frequency offset \hat{f}ₖ₋₁.

In operation S109a, the wireless communication device 200 may estimate a first channel ĥₖ₋₁ based on first channel characteristics, the first reference signal group, and the first signal yₖ₋₂. For example, the wireless communication device 200 may extract a correlation Cₖ₋₁. between the first reference signal group and the first signal yₖ₋₂ by using a filter (e.g., a matched filter). In addition, the wireless communication device 200 may estimate the first channel ĥₖ₋₁ based on a first correlation Cₖ₋₁.

In operation S111a, the wireless communication device 200 may estimate a second channel ĥₖ based on second channel characteristics, the second reference signal group, and the second signal yₖ₋₁. For example, the wireless communication device 200 may extract a correlation Cₖ between the second reference signal group and the second signal yₖ₋₁ by using a filter (e.g., a matched filter). When the wireless communication device 200 uses a matched filter, the second correlation Cₖ may be expressed as Equation 1 as follows.

$${C}_{k} = {\sum }_{t = 0}^{{n}_{k} - 1} {y}_{k - 1} [ t ] \cdot {( s [ t ] )}^{*} \qquad [ Equation 1 ]$$

In Equation 1, the second correlation Cₖ denotes a second correlation for the second reference signal group. s[t] denotes reference signals of the second reference signal group. An operation of extracting a correlation may also be referred to as channel estimation. The wireless communication device 200 may perform channel estimation on the second reference signal group based on various methods, and is not limited to the method using the matched filter described above. In addition, the wireless communication device 200 may estimate the second channel ĥₖ based on the correlation Cₖ. For example, the wireless communication device 200 may calculate a second residual phase offset \hat{θ}ₖ based on the correlation Cₖ and a phase difference of the second channel ĥₖ, and may estimate the second channel ĥₖ based on the second residual phase offset \hat{θ}ₖ. For example, the second channel ĥₖ may be expressed as Equation 2 below.

$${\hat{h}}_{k} = β ( {\hat{θ}}_{k} ) ( {\hat{h}}_{k - 1} ( 1 - α ) \cdot {e}^{j \frac{( {n}_{k - 1} + {n}_{k} )}{2} {\hat{θ}}_{k}} + α \frac{C}{{n}_{k}} ) \qquad [ Equation 2 ]$$

In Equation 2, a denotes a weight used for estimation of the first channel. β(\hat{θ}ₖ) may be a function that compensates for attenuation according to the size of an estimated first frequency offset, or may be obtained through a predefined lookup table (LUT).

In operation S113a, the wireless communication device 200 may calculate a second residual frequency offset \hat{f}ₖ based on the first channel ĥₖ₋₁ estimation and the second channel ĥₖ estimation. The relationship between the second residual frequency offset \hat{f}ₖ and the second residual phase offset \hat{θ}ₖ may be expressed as Equation 3 as follows.

$${\hat{f}}_{k} = \frac{1}{2 π {T}_{s}} {\hat{θ}}_{k} \qquad [ Equation 3 ]$$

The second residual phase offset \hat{θ}ₖ may be expressed as Equation 3 or Equation 4 below.

$$\begin{matrix}{\hat{θ}}_{k} = \frac{∠ ( {C}_{k} \cdot {\hat{h}}_{k - 1}^{*} )}{{\sum }_{l = 1}^{k - 1} ( \frac{{n}_{l} + {n}_{l + 1}}{2} )} & [ Equation 4 ] \\ {\hat{θ}}_{k} = \frac{∠ ( {\hat{h}}_{k} \cdot {\hat{h}}_{k - 1}^{*} )}{{D}_{k}} & [ Equation 5 ]\end{matrix}$$

In Equations 4 and 5, ĥₖ denotes an estimated channel in a k-th symbol group. \hat{θ}ₖ denotes an estimated residual phase offset in the k-th symbol group. Dₖ denotes an effective time difference between ĥ₁ and ĥₖ. Referring to Equations 4 and 5, the wireless communication device 200 may estimate the second residual phase offset \hat{θ}ₖ by considering a phase difference between the second correlation Cₖ and the first channel ĥₖ₋₁* estimation.

In addition, the wireless communication device 200 may estimate the second residual phase offset further based on the number of symbols of the second reference signal group, and the number of reference signal symbols received earlier than the second reference signal group. In Equation 4, the wireless communication device 200 calculates the second residual phase offset by considering

$${\sum }_{l = 1}^{k - 1} ( \frac{{n}_{l} + {n}_{l + 1}}{2} )$$

symbols and thus may estimate a residual phase offset by simply considering all previously received symbols. Accordingly, the wireless communication device 200 may estimate a more accurate residual frequency offset.

The wireless communication device 200 may compensate a received signal by applying the second residual phase offset \hat{θ}ₖ to the received signal starting from a symbol subsequent to the last symbol of the second reference signal group. For example, as shown in Equation 6 below, the wireless communication device 200 may apply the second residual phase offset \hat{θ}ₖ to a received signal based on the number nk of symbols of the second reference signal group.

$$\frac{{n}_{k} + 1}{2} {\hat{θ}}_{k} \qquad [ Equation 6 ]$$

The corrected received signal may be expressed as Equation 7 below.

$${y}_{k} [ t ] = {y}_{k - 1} [ t + {n}_{k} ] \cdot {e}^{- j ( \frac{{n}_{k} + 1}{2} + t ) {\hat{θ}}_{k}} \qquad [ Equation 7 ]$$

The wireless communication device 200 may repeat the above-described operations each time the last symbol of each reference signal group is received.

As described above, the wireless communication device 200 may calculate the second residual frequency offset \hat{f}ₖ based on the first channel ĥₖ₋₁ estimation and the second channel ĥₖ estimation. For example, referring to FIG. 3C, the wireless communication device 200 may, in operation S115a, calculate a phase difference between the first channel ĥₖ₋₁ estimation and the second channel ĥₖ estimation, and in operation S117a, calculate an effective time difference between the earliest received reference signal group and the second reference signal group. The wireless communication device 200 may calculate the second residual frequency offset \hat{f}ₖ by using “the phase difference between the first channel ĥₖ₋₁ estimation and the second channel ĥₖ estimation” and “the effective time difference between the earliest received reference signal group and the second reference signal group”. The effective time difference between the earliest received reference signal group and the second reference signal group may refer to a sum of “half the number of symbols included in the earliest received reference signal group”, “half the number of symbols included in the second reference signal group”, and “the number of symbols received between the earliest received reference signal group and the second reference signal group”.

FIG. 3D illustrates an operation method by which a wireless communication device performs channel estimation and frequency offset estimation by using decoded data, according to an embodiment. FIG. 3D may be described with reference to FIGS. 1 and 3A to 3C, and redundant descriptions may be omitted.

Referring to FIG. 3D, in operation S101b, the wireless communication device 100 may receive a first signal including a first data signal group.

In operation S103b, the wireless communication device 100 may calculate a first residual frequency offset based on the first signal.

In operation S105b, the wireless communication device 100 may receive a second signal that is subsequent to the first signal and includes a second data signal group.

In operation S107b, the wireless communication device 100 may compensate the phase of the second signal based on the first residual frequency offset.

In operation S109b, the wireless communication device 100 may estimate a first channel based on first channel characteristics, the first data signal group, and the first signal.

In operation S111b, the wireless communication device 100 may estimate a second channel based on second channel characteristics, the second data signal group, and the phase-compensated second signal.

In operation S113b, the wireless communication device 100 may calculate a second residual frequency offset based on the first channel estimation and the second channel estimation.

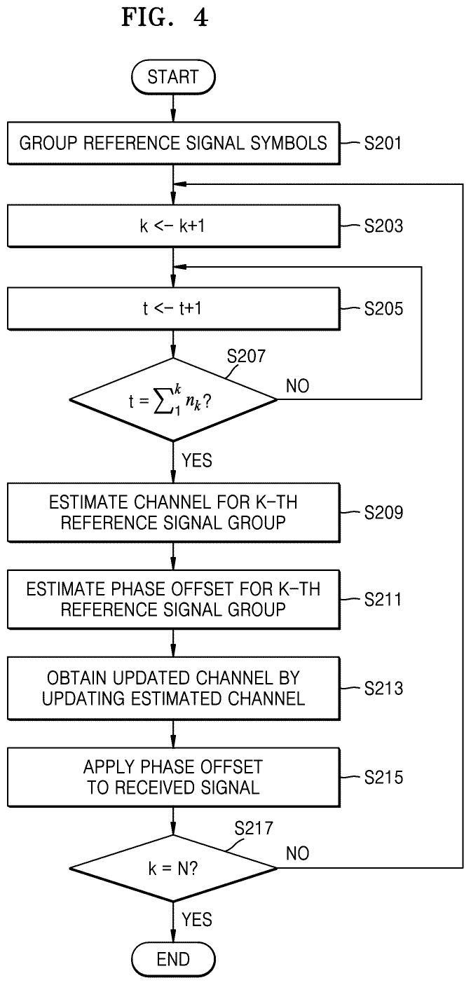

FIG. 4 illustrates a procedure in which a wireless communication device performs channel estimation and frequency offset estimation, according to an embodiment. FIG. 4 may be described with reference to FIGS. 1 and 3A to 3C.

Referring to FIG. 4, in operation S201, the wireless communication device 100 may group reference signal symbols. The wireless communication device 100 may generate N reference signal groups (N is an integer of 1 or greater), and nₖ denotes the number of symbols included in a k-th group (k is an integer of 1 or greater). t may denote a symbol index. In operation S201, t and k are 0 as initial conditions.

As another example, the wireless communication device 100 may group decoded data symbols.

In operations S203 and S205, t and k increase as the wireless communication device 100 receives a signal including a reference signal. Each time the wireless communication device 100 receives a reference signal symbol, t increases by 1, and each time the group of received reference signals changes, k increases by 1.

In operation S207, when a reference signal symbol index t is not yet the last symbol of the reference signal group nₖ (No), the wireless communication device 100 returns to operation S205 to receive a next reference signal symbol and increase the reference signal symbol index t by 1. When the reference signal symbol index t is still the last symbol of the reference signal group nₖ (Yes), the wireless communication device 100 enters operation S209.

In operation S209, the wireless communication device 100 estimates a channel Cₖ for a k-th reference signal group.

In operation S211, the wireless communication device 100 estimates a residual phase offset \hat{θ}ₖ for the k-th reference signal group. The phase offset may be expressed as Equation 8 below.

$${\hat{θ}}_{k} = \frac{∠ ( C \cdot {\hat{h}}_{k - 1}^{*} )}{{\sum }_{l = 1}^{k - 1} ( \frac{{n}_{l} + {n}_{l + 1}}{2} )} \qquad [ Equation 8 ]$$

In operation S213, the wireless communication device 100 may obtain an updated channel ĥₖ by updating the estimated channel Cₖ. A correlation may also be referred to as a channel. For example, the wireless communication device 100 may perform the update as shown in Equation 9 below.

$${\hat{h}}_{k} = β ( {\hat{θ}}_{k} ) ( {\hat{h}}_{k - 1} ( 1 - α ) \cdot {e}^{j \frac{( {n}_{k - 1} + {n}_{k} )}{2} {\hat{θ}}_{k}} + α \frac{C}{{n}_{k}} ) \qquad [ Equation 9 ]$$

a denotes a weight used for first channel estimation. β(\hat{θ}ₖ) may be a function that compensates for attenuation according to the size of an estimated first frequency offset, or may be obtained from a predefined LUT.

In operation S215, the wireless communication device 100 may apply the residual phase offset to a received signal. For example, the wireless communication device 100 may apply the residual phase offset as shown in Equation 10 below.

$${y}_{k} [ t ] = {y}_{k - 1} [ t + {n}_{k} ] \cdot {e}^{- j ( \frac{{n}_{k} + 1}{2} + t ) {\hat{θ}}_{k}} \qquad [ Equation 10 ]$$

In operation S217, when all reference signal groups, including the last reference signal group (the N-th group), have been received (Yes), frequency offset estimation may be terminated. When all reference signal groups, including the last reference signal group (the N-th group) have not been received (No), the wireless communication device 100 may return to operation S203 to repeat the above-described procedures for the next reference signal group.

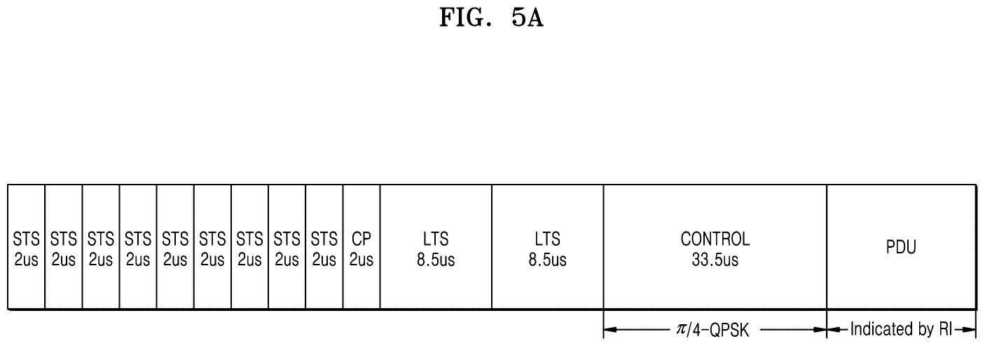

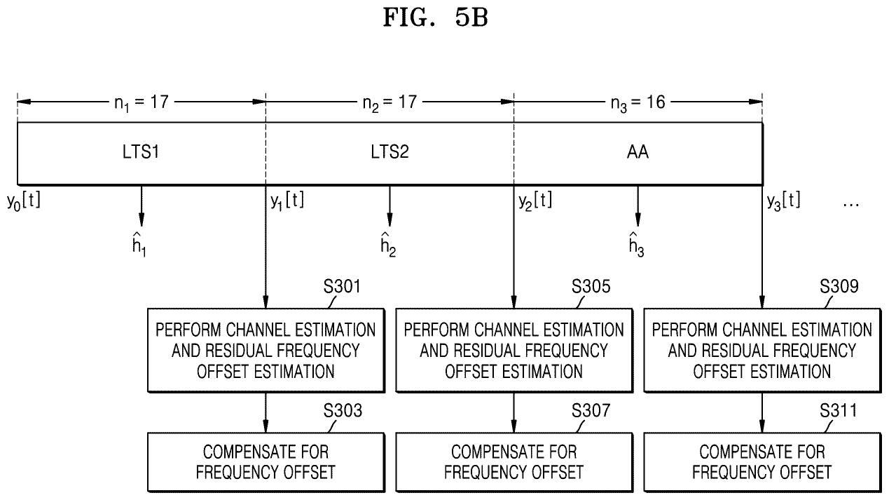

FIG. 5A illustrates a training packet structure of Bluetooth Low Energy (LE) High Data Throughput (HDT). FIG. 5A may be described with reference to FIG. 1.

Referring to FIG. 5A, the training packet structure of Bluetooth LE HDT may include a short training sequence (STS), an LTS, a control field, and a packet data unit (PDU). The STS may include four symbols for synchronization, channel estimation, and the like. The LTS may include a training sequence consisting of 17 symbols. The wireless communication device 100 according to an LE HDT system may transmit/receive the LTS twice in succession after transmitting/receiving 9 STSs. Thereafter, the wireless communication device 100 according to the LE HDT system may transmit/receive an AA. The AA may consist of 16 symbols or 32 symbols and may be included in the control field. A reference signal (e.g., an LTS) may be generated from a code transmitted from a higher layer (e.g., a medium access control (MAC) layer).

FIG. 5B illustrates a procedure in which a wireless communication device performs channel estimation and frequency offset estimation by using a reference signal of a Bluetooth LE HDT system, according to an embodiment. FIG. 5B may be described with reference to FIGS. 1 and 5A, and redundant descriptions may be omitted.

With regard to FIG. 5B, it is assumed that the wireless communication device 100 has confirmed synchronization of a received signal by using an STS. In addition, it is assumed that the wireless communication device 100 uses two LTSs and an AA of a control field to perform channel estimation and frequency offset estimation.

Referring to FIG. 5B, the wireless communication device 100 may divide reference signals. As a specific example, the wireless communication device 100 may configure LTS1 with n₁=17 symbols, LTS2 with n₂=17 symbols, and AA with n₃=16 symbols. y₀[t] denotes a received signal including a reference signal. yₖ[t] denotes a received signal corrected based on a k-th residual frequency offset. S_{LTS}[t] denotes an LTS reference signal. S_{AA}[t] denotes an AA reference signal. ĥₖ denotes an estimated and updated channel in a k-th group. \hat{θ}ₖ denotes an estimated residual phase offset in the k-th group. \hat{f}ₖ denotes an estimated residual frequency offset in the k-th group.

Referring to FIG. 5B, in operation S301, the wireless communication device 100 performs channel estimation and frequency offset estimation. In detail, the wireless communication device 100 may receive up to the last symbol of a reference signal group LTS1, which is the first reference signal group, and estimate a channel for the reference signal group LTS1.

The wireless communication device 100 may estimate the channel for the reference signal group LTS1 as follows.

$${C}_{1} = {\sum }_{t = 0}^{16} {y}_{0} [ t ] \cdot {s}_{LTS}^{*} [ t ] \qquad [ Equation 11 ]$$

In Equation 11, C₁ denotes a channel (correlation) estimated for the reference signal group LTS1. y₀[t] denotes a received signal including a reference signal. S*_{LTS}[t] denotes a complex conjugate of the LTS reference signal.

The wireless communication device 100 may estimate the residual phase offset as follows.

$${\hat{θ}}_{1} = 0 \qquad [ Equation 12 ]$$

That is, the wireless communication device 100 may estimate a residual phase offset of 0 for the first reference signal group LTS1.

The wireless communication device 100 may update the estimated channel (correlation) as follows.

$${\hat{h}}_{1} = \frac{{C}_{1}}{17} \qquad [ Equation 13 ]$$

For example, the wireless communication device 100 may update the estimated channel by dividing the estimated channel (correlation) C₁ by the number of symbols (i.e., 17) of the reference signal group LTS1.

In operation S303, the wireless communication device 100 may compensate for the frequency offset. The wireless communication device 100 may perform frequency offset correction on the received signal as expressed as Equation 14 as follows.

$${y}_{1} [ t ] = {y}_{0} [ t + 17 ] \qquad [ Equation 14 ]$$

In operation S305, the wireless communication device 100 performs channel estimation and frequency offset estimation. In detail, the wireless communication device 100 may receive up to the last symbol of a reference signal group LTS2, which is the second reference signal group, and estimate a channel for the reference signal group LTS2.

The wireless communication device 100 may estimate the channel for the reference signal group LTS2 as expressed as Equation 15 follows.

$${C}_{2} = {\sum }_{t = 0}^{16} {y}_{1} [ t ] \cdot {s}_{LTS}^{*} [ t ] \qquad [ Equation 15 ]$$

In Equation 15, C₂ denotes an estimated channel for the reference signal group LTS2. y₁[t] denotes a received signal corrected based on a first residual frequency offset. S*_{LTS}[t] denotes a complex conjugate of the LTS reference signal.

The wireless communication device 100 may estimate a residual phase offset and a residual frequency offset as expressed as Equation 16 as follows.

$${\hat{θ}}_{2} = \frac{( ∠ {C}_{2} \cdot {\hat{h}}_{1}^{*} )}{17} , {\hat{f}}_{2} = \frac{{\hat{θ}}_{2}}{2 π {T}_{s}} \qquad [ Equation 16 ]$$

The wireless communication device 100 may update the estimated channel as follows.

$${\hat{h}}_{2} = \frac{{C}_{2}}{17} \qquad [ Equation 17 ]$$

For example, the wireless communication device 100 may update the estimated channel by dividing the estimated channel (correlation) C₂ by the number of symbols (i.e., 17) of the reference signal group LTS2.

In operation S307, the wireless communication device 100 may compensate for the frequency offset. In detail, the wireless communication device 100 may perform frequency offset compensation on the received signal as expressed as Equation 18 as follows.

$${y}_{2} [ t ] = {y}_{1} [ t + 17 ] \cdot {e}^{- j ( 9 + t ) {\hat{θ}}_{2}} \qquad [ Equation 18 ]$$

In Equation 18, the wireless communication device 100 may compensate the received signal for the residual frequency offset by e^{-j9}\hat{θ}2. In addition, the wireless communication device 100 may perform additional compensation by \hat{θ}2 starting from the beginning of the AA. The received signal may be expressed as Equation 19 as follows.

$${y}_{2} [ t ] = {y}_{0} [ t + 34 ] \cdot {e}^{- j ( 9 + t ) {\hat{θ}}_{2}} \qquad [ Equation 19 ]$$

In operation S309, the wireless communication device 100 may perform channel estimation and frequency offset estimation. In detail, the wireless communication device 100 may receive up to the last symbol of a reference signal group AA, which is the third reference signal group, and estimate a channel for the reference signal group AA.

The wireless communication device 100 may estimate the channel for the reference signal group AA as follows.

$${C}_{3} = {\sum }_{t = 0}^{15} {y}_{2} [ t ] \cdot {s}_{AA}^{*} [ t ] \qquad [ Equation 20 ]$$

In equation 20, C₃ refers to an estimated channel (correlation) for the reference signal group AA. y₂[t] denotes a received signal corrected based on a second residual frequency offset. S*_{AA}[t] denotes a complex conjugate of the AA reference signal.

The wireless communication device 100 may estimate a phase offset and a frequency offset as expressed as Equation 21 as follows.

$${\hat{θ}}_{3} = ( ∠ {C}_{3} \cdot {\hat{h}}_{2}^{*} ) / 33.5 , {\hat{f}}_{3} = {\hat{θ}}_{3} / 2 π {T}_{s} \qquad [ Equation 21 ]$$

The wireless communication device 100 may update the estimated channel as expressed as Equation 22 as follows.

$${\hat{h}}_{3} = \frac{{C}_{3}}{16} \qquad [ Equation 22 ]$$

For example, the wireless communication device 100 may update the estimated channel by dividing the estimated channel C₃ by the number of symbols (i.e., 16) of the reference signal group AA.

In operation S311, the wireless communication device 100 may compensate for the frequency offset. The wireless communication device 100 may perform frequency offset compensation on the received signal as follows.

$${y}_{3} [ t ] = {y}_{2} [ t + 16 ] \cdot {e}^{- j ( 8.5 + t ) {\hat{θ}}_{3}} \qquad [ Equation 23 ]$$

In Equation 23, the wireless communication device 100 may compensate the received signal for the residual frequency offset by e^{-j8.5}\hat{θ}3. In addition, the wireless communication device 100 may perform additional compensation by \hat{θ}3. The received signal may be expressed as Equation 24 as follows.

$${y}_{3} [ t ] = {y}_{2} [ t + 16 ] \cdot {e}^{- j ( 8.5 + t ) {\hat{θ}}_{3}} = {y}_{0} [ t + 50 ] \cdot {e}^{- j ( 25 + t ) {\hat{θ}}_{2}} \cdot {e}^{- j ( 8.5 + t ) {\hat{θ}}_{3}} = {y}_{0} [ t + 50 ] \cdot {e}^{- j ( 25 {\hat{θ}}_{2} + 8.5 {\hat{θ}}_{3} )} \cdot {e}^{- j ( {\hat{θ}}_{2} + {\hat{θ}}_{3} ) t} \qquad [ Equation 24 ]$$

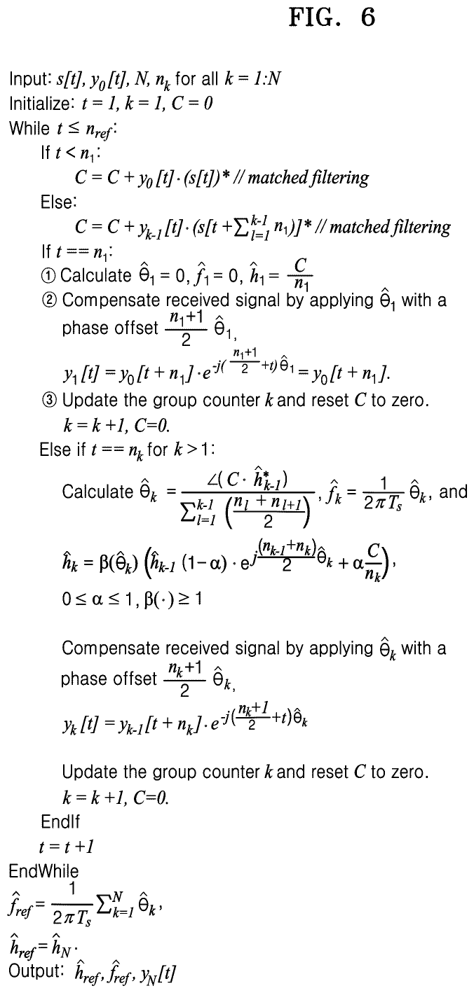

FIG. 6 shows a pseudoalgorithm for a wireless communication device to estimate a channel and a frequency offset by using a reference signal, according to an embodiment. FIG. 6 may be described with reference to FIGS. 1 and 3A to 3C.

The pseudoalgorithm of FIG. 6 shows an operation by which the wireless communication device 100 divides a total of n_{ref} reference signals into N groups {n₁, n₂, . . . , n_{N}} in time order, and performs channel estimation, frequency offset estimation, and compensation a total of N times. y₀[t] denotes a received signal including reference signals. s[t] denotes a reference signal. yₖ[t] denotes a received signal corrected based on a k-th residual frequency offset. ĥₖ denotes an estimated and updated channel in a k-th group. \hat{θ}ₖ denotes an estimated residual phase offset in the k-th group. \hat{f}ₖ denotes an estimated residual frequency offset in the k-th group. ĥₖ and \hat{θ}ₖ may be used for decoding starting from the first symbol of a (k+1)-th reference signal group or may be used for frequency offset correction of the received signal. a denotes a weight used for first channel estimation. β(\hat{θ}ₖ) may be a function that compensates for attenuation according to the size of an estimated first frequency offset, or may be obtained from a predefined LUT. In the pseudoalgorithm of FIG. 6, it is assumed that channel estimation is performed through a matched filter. In addition to the matched filter, various channel estimation algorithms may be used, and when various channel estimation algorithms are used, a phase offset value may be modified to suit the corresponding channel estimation algorithm.

Referring to FIG. 6, C may denote a correlation and may be obtained through matched filtering. k may be referred to as a group counter. When k=1 and a time t is equal to n₁, the wireless communication device 100 may calculate \hat{θ}₁, \hat{f}₁, and ĥ₁ as shown in FIG. 6 (\textcircled{1}). The wireless communication device 100 may compensate a received signal by applying a phase offset

$$\frac{{n}_{1} + 1}{2} {\hat{θ}}_{1}$$

along with \hat{θ}₁ to the received signal (\textcircled{2}). The wireless communication device 100 may update the group counter k and reset the correlation C to 0 (\textcircled{3}). The group counter k increases by 1 (k=k+1)

Referring to FIG. 6, residual phase offset estimation in the k-th reference signal group is calculated as shown in Equation 25 below.

$${\hat{θ}}_{k} = \frac{∠ ( C \cdot {\hat{h}}_{k - 1}^{*} )}{{\sum }_{l = 1}^{k - 1} ( \frac{{n}_{l} + {n}_{l + 1}}{2} )} \qquad [ Equation 25 ]$$

The wireless communication device 100 may apply the estimated residual phase offset \hat{θ}ₖ starting from the first symbol of the (k+1)-th reference signal group, and also additionally change the phase of the received signal by

$${e}^{- j ( \frac{{n}_{k} + 1}{2} + t ) {\hat{θ}}_{k}}$$

each time it receives the last symbol of the k-th reference signal group. Thus, “a phase difference between a channel for the previous reference signal group and a channel for the current reference signal group” may be equal to “a phase difference between estimated channels of the earliest reference signal group to the current reference signal group”. When k>1 and the time t is equal to nₖ, the wireless communication device 100 may compensate the received signal by applying a phase offset

$$\frac{{n}_{k} + 1}{2} {\hat{θ}}_{k}$$

along with \hat{θ}ₖ to the received signal.

Unlike FIG. 6, an estimated and updated channel ĥₖ in the k-th group may be calculated as shown in Equation 26 below.

$${\hat{h}}_{k} = \frac{{\hat{h}}_{k - 1} ( {\sum }_{l = 1}^{k - 1} {n}_{l} ) \cdot {e}^{j \frac{( {n}_{k - 1} + {n}_{k} )}{2} {\hat{θ}}_{k}} + C}{{\sum }_{l = 1}^{k} {n}_{l}} \qquad [ Equation 26 ]$$

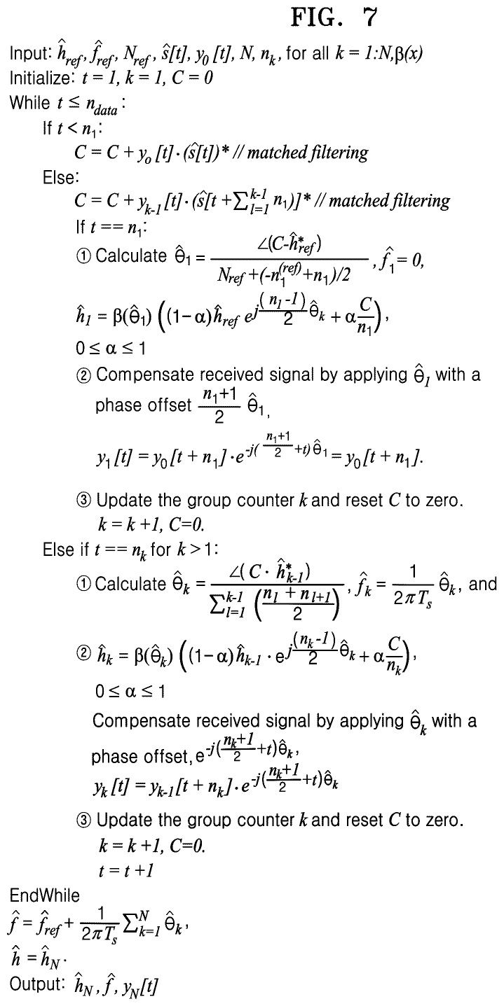

FIG. 7 shows a pseudoalgorithm for a wireless communication device to perform channel estimation and frequency offset estimation by using decoded data, according to an embodiment. FIG. 7 may be described with reference to FIGS. 1 and 6, and redundant descriptions may be omitted.

It is assumed that Nᵣₑf reference signal symbols are divided into groups {n₁^{(ref)}, n₂^{(ref)}, . . . , nₙ_{_{ref}}^{(ref)}} and then \hat{f}_{ref} and ĥ_{ref} are estimated. The pseudoalgorithm of FIG. 7 shows an operation by which the wireless communication device 100 divides received data symbols into N groups {n₁, n₂, . . . , n_{N}} in time order, and performs channel estimation, frequency offset estimation, and compensation a total of N times. When data symbol reception begins, a received signal related to frequency offset estimation and channel estimation is referred to as y₀[t]. A decoded data signal is referred to as ŝ[t].

Referring to FIG. 7, C may denote a correlation and may be obtained through matched filtering. k may be referred to as a group counter. When k=1 and a time t is equal to n₁, the wireless communication device 100 may calculate \hat{θ}₁, \hat{f}ₖ, and ĥ₁ as shown in FIG. 7 (\textcircled{1}). The wireless communication device 100 may compensate the received signal by applying a phase offset

$$\frac{{n}_{1} + 1}{2} {\hat{θ}}_{1}$$

along with \hat{θ}₁ to the received signal (\textcircled{2}). The wireless communication device 100 may update the group counter k and reset the correlation C to 0 (\textcircled{3}). The group counter k increases by 1 (k=k+1)

When k>1 and the time t is equal to nₖ, the wireless communication device 100 may calculate \hat{θ}ₖ, \hat{f}ₖ, and ĥₖ as shown in FIG. 7. The wireless communication device 100 may compensate the received signal by applying a phase offset

$${e}^{- j ( \frac{{n}_{k} + 1}{2} + t ) {\hat{θ}}_{k}}$$

along with \hat{θ}ₖ to the received signal. The wireless communication device 100 may update the group counter k and reset the correlation C to 0 (\textcircled{3}). The group counter k increases by 1 (k=k+1)

Unlike FIG. 7, ĥ₁ may also be calculated as shown in Equation 27 below.

$${\hat{h}}_{1} = \frac{{N}_{ref} {\hat{h}}_{ref} {e}^{j ( \frac{{n}_{1} - 1}{2} ) {\hat{θ}}_{1}} + C}{{N}_{ref} + {n}_{1}} \qquad [ Equation 27 ]$$

Unlike FIG. 7, ĥₖ may also be calculated as shown in Equation 28 below.

$${\hat{h}}_{k} = \frac{( ( {N}_{ref} + {\sum }_{l = 1}^{k - 1} {n}_{l} ) {\hat{h}}_{k - 1} \cdot {e}^{j ( \frac{{n}_{k} - 1}{2} ) {\hat{θ}}_{k}} + C )}{{N}_{ref} + {\sum }_{l = 1}^{k} {n}_{l}} \qquad [ Equation 28 ]$$

The method using data symbols is similar to the method using reference signals, except that a decoded data symbol is used instead of a reference signal.

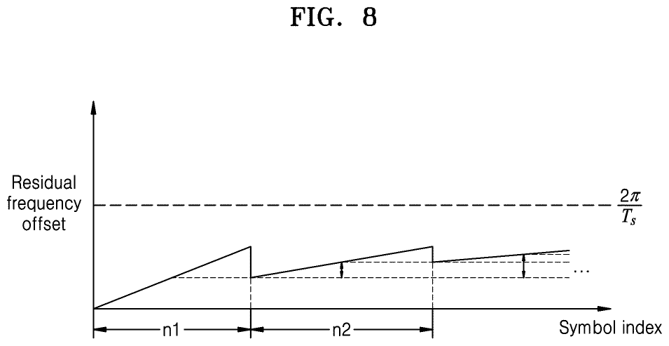

FIG. 8 shows residual frequency offsets estimated by a wireless communication device according to symbol indices, according to an embodiment. FIG. 8 may be described with reference to FIGS. 1 and 3A to 3C.

Reference signals may be divided into N groups. Referring to FIG. 8, among the N groups, a first reference signal group that is received earliest includes n₁ symbols. A reference signal group that is received second includes n₂ symbols. The wireless communication device 100 may receive the last symbol of the first reference signal group and estimate a residual frequency offset. The residual frequency offset may be applied starting from the first symbol of the second reference signal group.

Referring to FIG. 8, the residual frequency offset decreased from the first symbol of the second reference signal group. As such, the wireless communication device 100 according to embodiments of the inventive concept may perform channel estimation and residual frequency offset estimation each time it receives the last symbol of a reference signal group, and accordingly correct the residual frequency offset.

In addition, assuming that a third received reference signal group includes n₃ symbols, (n₁/2)+(n₂)+(n₃/2) symbols may be considered in a process in which the wireless communication device 100 determines a residual frequency offset for the third received reference signal group. n₁, n₂, and n₃ are positive integers.

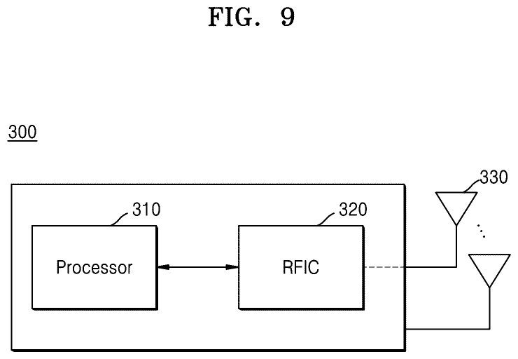

FIG. 9 is a block diagram of a wireless communication device according to an embodiment.

Referring to FIG. 9, a wireless communication device 300 may include a processor 310, a radio-frequency integrated circuit (RFIC) 320, and a plurality of antennas 330.

In an embodiment, the wireless communication device 300 may include the RFIC 320, the plurality of antennas 330, and “the processor 310 configured to receive a signal including reference signals through the RFIC 320”. The processor 310 may receive a signal including a reference signal through the RFIC 320 and the plurality of antennas 330. The wireless communication device 300 may further include components used for transmitting and receiving signals, and is not limited to including only the components described above.

The processor 310 may receive a first signal including a first reference signal group, and calculate a first residual frequency offset based on the first signal. The processor 310 may receive a second signal that is subsequent to the first signal and includes a second reference signal group. The processor 310 may compensate the phase of the second signal based on the first residual frequency offset. The processor 310 may estimate a first channel based on first channel characteristics, the first reference signal group, and the first signal. The processor 310 may estimate a second channel based on second channel characteristics, the second reference signal group, and the phase-compensated second signal. The processor 310 may calculate a second residual frequency offset based on the first channel estimation and the second channel estimation.

The processor 310 may calculate a phase difference between the first channel estimation and the second channel estimation, and may calculate the second residual frequency offset by calculating an effective time difference between the earliest received reference signal group and the second reference signal group. The effective time difference may be a sum of half the number of symbols included in the earliest received reference signal group, half the number of symbols included in the second reference signal group, and the number of symbols received between the earliest received reference signal group and the second reference signal group.

The processor 310 may adjust the number of symbols of the second reference signal group based on the size of the first residual frequency offset. For example, when the size of the first residual frequency offset is greater than or equal to a threshold value, the processor 310 may adjust the number of symbols of the second reference signal group to be less than the number of symbols of the first reference signal group. As another example, when the size of the first residual frequency offset is less than the threshold value, the processor 310 may adjust the number of symbols of the second reference signal group to be greater than the number of symbols of the first reference signal group.

The processor 310 may receive a third signal that is subsequent to the second signal and includes a third reference signal group. In addition, the processor 310 may compensate the phase of the third signal based on the second residual frequency offset. The first reference signal group and the second reference signal group may include any one of an LTS and an AA.

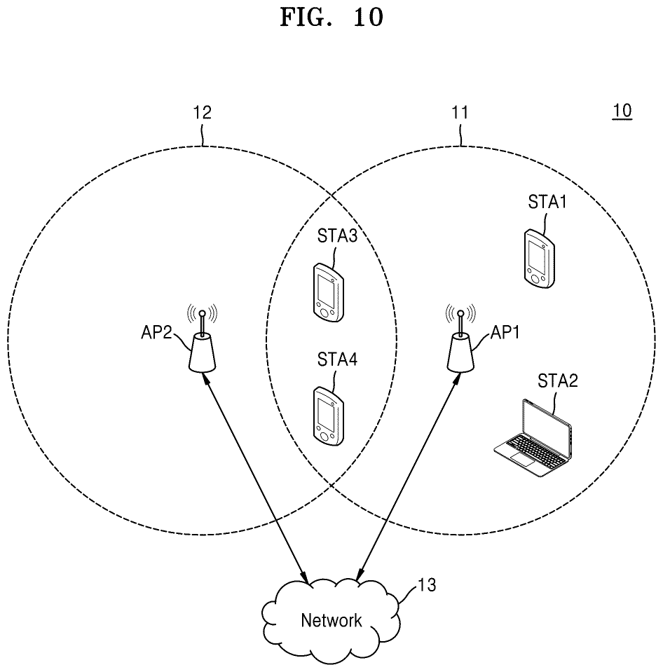

FIG. 10 is a diagram illustrating a wireless communication system that may include a wireless communication device, according to an embodiment. FIG. 10 may be described with reference to FIGS. 1 and 3A to 3C.

In detail, FIG. 10 illustrates a wireless local area network (WLAN) system as an example of a wireless communication system 10. Although embodiments will be described in detail by focusing a wireless communication system based on orthogonal frequency-division multiplexing (OFDM) or OFDM access (OFDMA), in particular, the Institute of Electrical and Electronics Engineers (IEEE) 802.11 standard, the inventive concept may also be applied to other communication systems with a similar technological background and channel type (e.g., a cellular communication system such as Long-Term evolution (LTE), LTE-Advanced (LTE-A), New Radio (NR)/5th Generation (5G), wireless broadband (WiBro), or Global System for Mobile communications (GSM), or a short-range communication such as Bluetooth or near-field communication (NFC), and this may be determined by those skilled in the art of the inventive concept.

In addition, various functions described below may be implemented or supported by artificial intelligence technology or one or more computer programs, and each of the computer programs is configured with computer-readable program code and embodied in a computer-readable medium. The terms “application” and “program” refer to one or more computer programs, software components, sets of instructions, procedures, functions, objects, classes, instances, relevant data, or a portion thereof adapted for implementation of suitable computer-readable program code. The phrase “computer-readable program code” includes any type of computer code, including source code, object code, and executable code. The phrase “computer readable medium” includes any type of medium capable of being accessed by a computer, such as read-only memory (ROM), random-access memory (RAM), a hard disk drive, a compact disc (CD), a digital video disc (DVD), or any other type of memory. A “non-transitory” computer-readable medium excludes wired, wireless, optical, or other communication links that transmit transitory electrical or other signals. A non-transitory computer-readable medium includes media where data may be permanently stored and media where data may be stored and later overwritten, such as a rewritable optical disc or an erasable memory device.

In various embodiments to be described below, a hardware approach will be described as an example. However, the various embodiments include a technology using both hardware and software, and thus do not exclude a software-based approach.

Hereinafter, terms indicating control information, terms indicating entry, terms indicating network entities, terms indicating messages, and terms indicating components of a device are examples for convenience of description. Accordingly, embodiments of the inventive concept are not limited to the terms used herein, and may use other terms having technically identical or similar meanings.

Referring to FIG. 10, the wireless communication system 10 may include first and second access points AP1 and AP2, a first station STA1, a second station STA2, a third station STA3, and a fourth station STA4. The first and second access points AP1 and AP2 may access a network 13 including an Internet network, an internet protocol (IP) network, or any other network. The first access point AP1 may provide the first station STA1, the second station STA2, the third station STA3, and the fourth station STA4 with access to the network 13, within a first coverage area 11, and the second access point AP2 may provide the third and fourth stations STA3 and STA4 with access to the network 13, within a second coverage area 12. In some embodiments, the first and second access points AP1 and AP2 may communicate with at least one of the first station STA1, the second station STA2, the third station STA3, and the fourth station STA4, based on Wireless Fidelity (Wi-Fi) or any other WLAN access technology.

The term ‘access point’ may be referred to as ‘router’, ‘gateway’, or the like, and the term ‘station’ may be referred to as ‘mobile station’, ‘subscriber station’, ‘terminal’, ‘mobile terminal’, ‘wireless terminal’, ‘user equipment’, ‘user’, or the like. The station may be a mobile device such as a mobile phone, a laptop computer, or a wearable device, or may be a stationary device such as a desktop computer or a smart television (TV).

The access point may determine a channel bandwidth used to communicate with a station, as any one of a plurality of channel bandwidths. In embodiments of the inventive concept, a channel bandwidth may also be referred to as a bandwidth. In an example embodiment, the plurality of channel bandwidths may include, but are not limited to, 20 MHz, 40 MHz, 80 MHz, 160 MHz, 320 MHz, and 640 MHz.

The access point and the station according to an embodiment may correct a received signal based on the above-described frequency offset estimation and channel estimation. For example, the access point and the station may divide reference signals into reference signal groups. The reference signal groups may include a first reference signal group and a second reference signal group received earlier than the first reference signal group. The access point and the station may receive a first signal including the first reference signal group and calculate a first residual frequency offset based on the first signal. The access point and the station may receive a second signal that is subsequent to the first signal and includes the second reference signal group. The access point and the station may compensate the phase of the second signal based on the first residual frequency offset. The access point and the station may estimate a first channel based on first channel characteristics, the first reference signal group, and the first signal. The access point and the station may estimate a second channel based on second channel characteristics, the second reference signal group, and the phase-compensated second signal. The access point and the station may calculate a second residual frequency offset based on the first channel estimation and the second channel estimation. The access point and the station may calculate a phase difference between the first channel estimation and the second channel estimation, and may calculate the second residual frequency offset by calculating an effective time difference between the earliest received reference signal group and the second reference signal group.

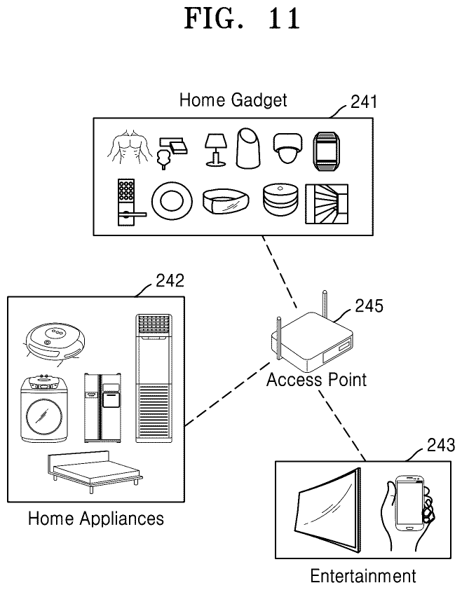

FIG. 11 is a diagram illustrating examples of a device for wireless communication according to an embodiment.

In detail, FIG. 11 illustrates an Internet-of-Things (IoT) network system including home gadgets 241, home appliances 242, entertainment devices 243, and an access point 245.

In some embodiments, the devices for wireless communication illustrated in FIG. 11 may perform residual frequency offset estimation and channel estimation as described above, and may correct a received signal based on an estimated residual frequency offset.

Embodiments have been described herein and illustrated in the drawings. Although the embodiments have been described herein by using specific terms, they are used only for the purpose of explaining embodiments of the inventive concept and not used to limit the meaning or scope of the claims. Therefore, those of skill in the art will understand that various modifications and other equivalent embodiments may be derived from the embodiments described herein. Therefore, the true technical protection scope of the inventive concept should be determined by the appended claims.

While the inventive concept has been particularly shown and described with reference to embodiments thereof, it will be understood that various changes in form and details may be made therein without departing from the spirit and scope of the following claims.

What is claimed is:

1. An operation method of a wireless communication device, the operation method comprising:
receiving a first signal comprising a first reference signal group;
calculating a first residual frequency offset based on the first signal;
receiving a second signal that is subsequent to the first signal and comprises a second reference signal group;
compensating a phase of the second signal based on the first residual frequency offset;
estimating a first channel based on first characteristics of the first channel, the first reference signal group, and the first signal;
estimating a second channel based on second characteristics of the second channel, the second reference signal group, and the second signal of which the phase is compensated; and
calculating a second residual frequency offset based on the first channel estimation and the second channel estimation.

2. The operation method of claim 1, wherein the calculating of the second residual frequency offset based on the first channel estimation and the second channel estimation comprises:
calculating a phase difference between the first channel estimation and the second channel estimation; and
calculating an effective time difference between an earliest received reference signal group and the second reference signal group.

3. The operation method of claim 2, wherein the effective time difference is a sum of half a number of symbols included in the earliest received reference signal group, half a number of symbols included in the second reference signal group, and a number of symbols received between the earliest received reference signal group and the second reference signal group.

4. The operation method of claim 1, further comprising adjusting a number of symbols of the second reference signal group based on a size of the first residual frequency offset.

5. The operation method of claim 4, wherein the adjusting of the number of symbols of the second reference signal group comprises, based on the size of the first residual frequency offset being greater than or equal to a threshold value, adjusting the number of symbols of the second reference signal group to be greater than the number of symbols of the first reference signal group.

6. The operation method of claim 1, further comprising:
receiving a third signal that is subsequent to the second signal and comprises a third reference signal group; and
compensating a phase of the third signal based on the second residual frequency offset.

7. The operation method of claim 1, wherein the first reference signal group and the second reference signal group comprise any one of a long training sequence (LTS) and an access address (AA).

8. A wireless communication device, comprising:
a radio-frequency integrated circuit (RFIC); and
a processor configured to:
receive through the RFIC a first signal comprising a first reference signal group, calculate a first residual frequency offset based on the first signal, receive through the RFIC a second signal that is subsequent to the first signal and comprises a second reference signal group, compensate a phase of the second signal based on the first residual frequency offset, estimate a first channel based on first channel characteristics, the first reference signal group, and the first signal, estimate a second channel based on second channel characteristics, the second reference signal group, and the second signal of which the phase is compensated, and calculate a second residual frequency offset based on the first channel estimation and the second channel estimation.

9. The wireless communication device of claim 8, wherein the processor is further configured to calculate the second residual frequency offset by calculating a phase difference between the first channel estimation and the second channel estimation, and calculate an effective time difference between an earliest received reference signal group and the second reference signal group.

10. The wireless communication device of claim 9, wherein the effective time difference is a sum of half a number of symbols included in the earliest received reference signal group, half a number of symbols included in the second reference signal group, and a number of symbols received between the earliest received reference signal group and the second reference signal group.

11. The wireless communication device of claim 8, wherein the processor is further configured to adjust a number of symbols of the second reference signal group based on a size of the first residual frequency offset.

12. The wireless communication device of claim 11, wherein the processor is further configured to, based on the size of the first residual frequency offset being greater than or equal to a threshold value, adjust the number of symbols of the second reference signal group to be greater than the number of symbols of the first reference signal group.

13. The wireless communication device of claim 8, wherein the processor is further configured to receive a third signal that is subsequent to the second signal and comprises a third reference signal group, and compensate a phase of the third signal based on the second residual frequency offset.

14. The wireless communication device of claim 8, wherein the first reference signal group and the second reference signal group comprise any one of a long training sequence (LTS) and an access address (AA).

15. An operation method of a wireless communication device, the operation method comprising:
receiving a first signal comprising a first data signal group;
calculating a first residual frequency offset based on the first signal;
receiving a second signal that is subsequent to the first signal and comprises a second data signal group;
compensating a phase of the second signal based on the first residual frequency offset;
estimating a first channel based on first channel characteristics, the first data signal group, and the first signal;
estimating a second channel based on second channel characteristics, the second data signal group, and the second signal of which the phase is compensated; and
calculating a second residual frequency offset based on the first channel estimation and the second channel estimation.

16. The operation method of claim 15, wherein the calculating of the second residual frequency offset based on the first channel estimation and the second channel estimation comprises:
calculating a phase difference between the first channel estimation and the second channel estimation; and
calculating an effective time difference between an earliest received data signal group and the second data signal group.

17. The operation method of claim 16, wherein the effective time difference is a sum of half a number of symbols included in the earliest received data signal group, half a number of symbols included in the second data signal group, and a number of symbols received between the earliest received data signal group and the second data signal group.

18. The operation method of claim 15, further comprising adjusting a number of symbols of the second data signal group based on a size of the first residual frequency offset.

19. The operation method of claim 18, wherein the adjusting of the number of symbols of the second data signal group comprises, based on the size of the first residual frequency offset being greater than or equal to a threshold value, adjusting the number of symbols of the second data signal group to be greater than the number of symbols of the first data signal group.

20. The operation method of claim 15, further comprising:
receiving a third signal that is subsequent to the second signal and comprises a third data signal group; and
compensating a phase of the third signal based on the second residual frequency offset.
